(19) United States
(12) Patent Application Publication
(10) Pub. No.: US 2025/0349451 A1
(43) Pub. Date: Nov. 13, 2025

(54) BI-STABLE DEVICE

(71) Applicant: Dana Automotive Systems Group, LLC, Maumee, OH (US)

(72) Inventors: Ivan LOPEZ, Ypsilanti, MI (US); Nathan D. MANDERY, Perrysburg, OH (US); Kyle MOURDOCK, Bowling Green, OH (US)

(21) Appl. No.: 18/659,601

(22) Filed: May 9, 2024

(51) Int. Cl. H01F 7/08; F16H 48/34; H01F 7/128

(52) U.S. Cl. CPC H01F 7/081; F16H 48/34; H01F 7/128

(57) ABSTRACT

Methods and systems for fabricating and operating a bi-stable solenoid actuator are described. The system may include permanent magnets that are arranged in a circle. The permanent magnets may provide sufficient force to maintain a differential in a locked state when electric power is not applied to a coil that operates as an electro-magnet.

### TECHNICAL FIELD

The present disclosure relates to a bi-stable device for controlling a two state device. The two state device may be an electric locking differential set of gears or a differential gear set that allows two axle shafts to rotate together or independently.

### BACKGROUND AND SUMMARY

A set of wheels may be mechanically coupled to a differential set of gears. The differential set of gears allows each of the wheels in the set of wheels to rotate at different speeds. This allows a vehicle that includes the differential to negotiate a turn without dragging one of the wheels. However, there may be times when it may be desirable for the two wheels to rotate at the same speed. For example, if the vehicle is traveling in a straight direction on a surface having a low coefficient of friction, it may be desirable to lock the differential so that the two wheels that are coupled to the differential rotate at a same speed so that vehicle traction may be increased. One way to lock the differential may be to continuously apply electric power to a solenoid that locks the differential while differential locking is desired. Yet, continuously applying electric power to a solenoid may deplete charge from a battery. Therefore, it may be desirable to provide a way of locking a differential without having to continuously supply electric power to a solenoid.

The inventors have recognized the aforementioned challenges and developed a bi-stable solenoid actuator, comprising: an annular steel housing that includes a U-shaped channel; a winding wrapped around an annular winding carrier; an annular steel piston; one or more permanent magnets arranged in a circle; an annular steel cover; and a return spring.

By building a bi-stable solenoid actuator, it may be possible to lock a differential set of gears by applying electric power to the bi-stable solenoid actuator and keep the differential set of gears locked even when power is removed from the bi-stable solenoid actuator. In particular, permanent magnets and a steel housing and steel cover allow a magnetic field to be sufficient to hold the differential set of gears locked.

The bi-stable solenoid actuator that is described herein may provide several advantages. Specifically, the bi-stable solenoid actuator may hold a differential gear set in a locked state or an unlocked state without having to supply electric power to maintain the differential gear set operating state. Further, the bi-stable solenoid actuator is annular in shape so that it may supply uniform holding power in an engaged state and/or during actuation of the bi-stable solenoid actuator. Consequently, a cam ring may be operated on by the bi-stable solenoid actuator to engage a side gear without lurching to one side or another side, thereby reducing a possibility of binding the mechanism.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a schematic view of an example vehicle that includes a locking differential gear set.

FIG. 2 shows a perspective view of an example bi-stable solenoid actuator.

FIG. 3 shows a cross-section view of the bi-stable solenoid actuator.

FIG. 4 shows an exploded view of the bi-stable solenoid actuator.

FIG. 5 shows an exploded view of the bi-stable solenoid actuator integrated into a split differential disconnect.

FIGS. 6-11 shows magnetic field paths when the bi-stable solenoid actuator is in engaged and disengaged operating states.

FIG. 12 is a flowchart of an example method for building and operating the bi-stable solenoid actuator.

FIG. 13 is an exploded via of the bi-stable solenoid actuator as an electronic differential lock.

### DETAILED DESCRIPTION

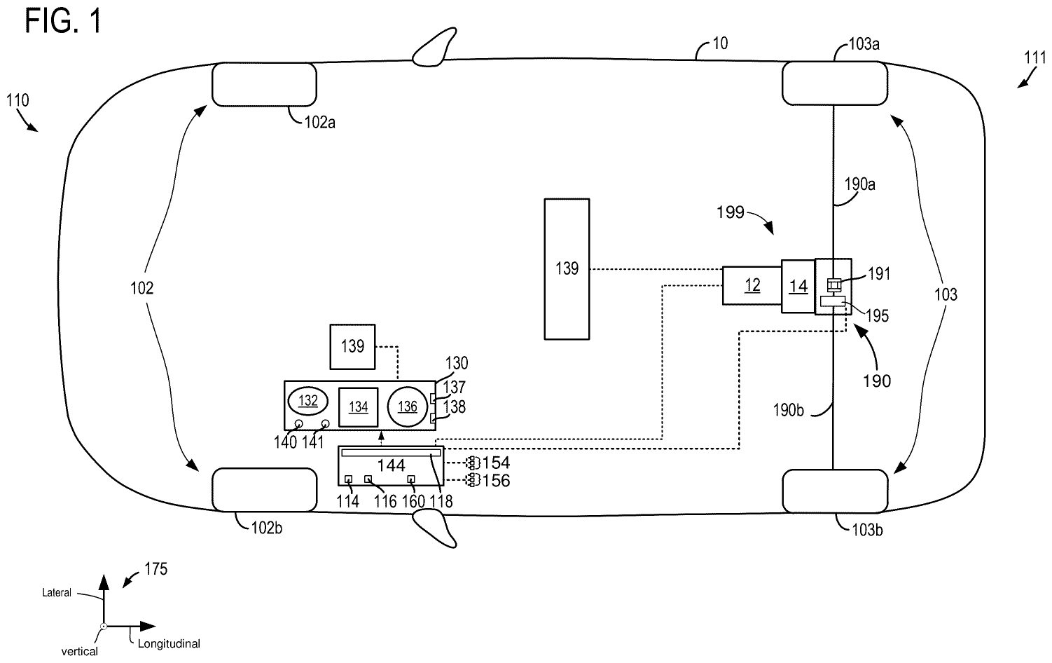

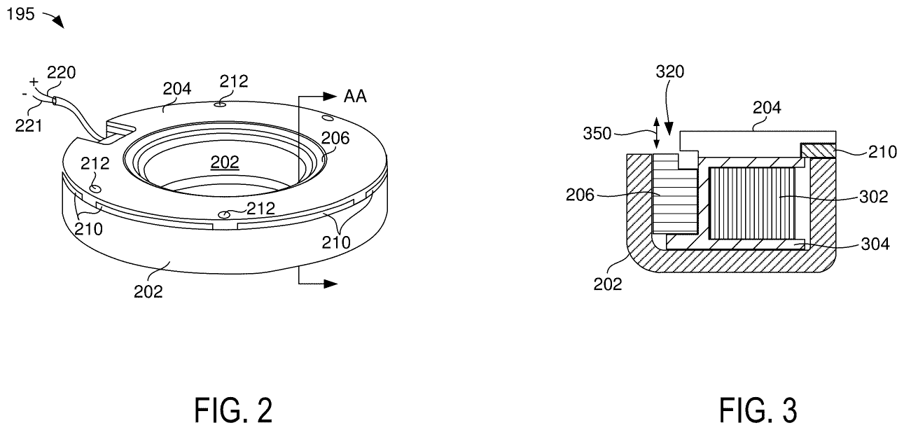

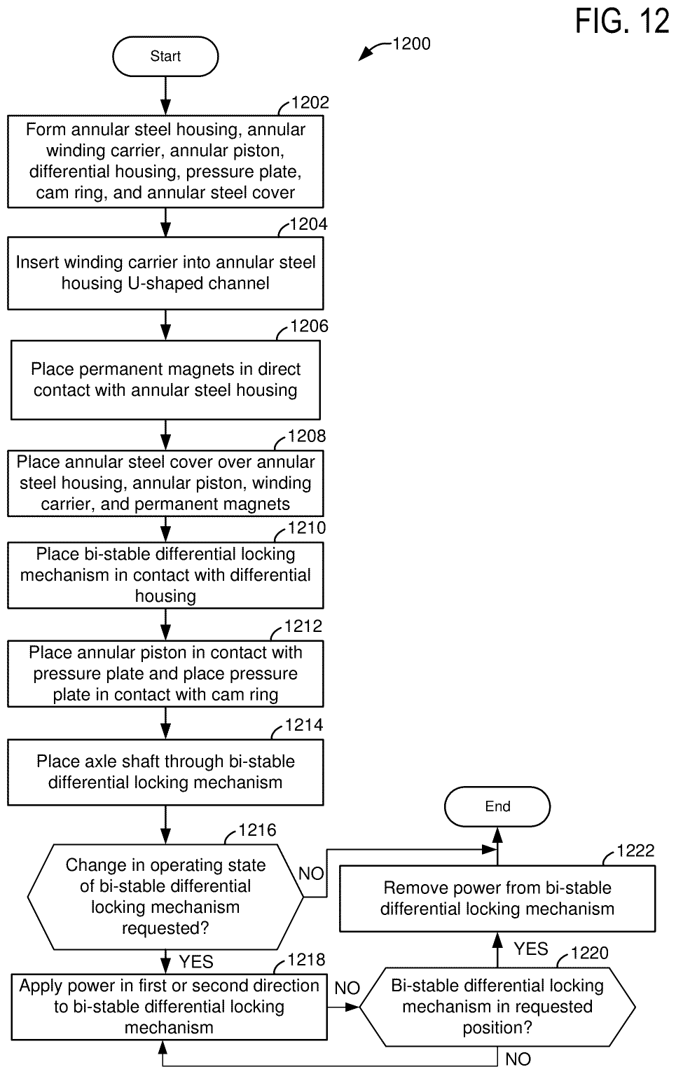

The following description relates to systems and methods for a bi-stable solenoid. The bi-stable solenoid allows a differential gear set to remain in its most recent operating state (e.g., engaged or disengaged) even when electric power is not applied to the bi-stable differential gear set locking mechanism. The bi-stable solenoid may be deployed in a vehicle as shown in FIG. 1. FIGS. 2-11 and 13 shown different views of at least portions of the bi-stable solenoid and application examples. Finally, FIG. 12 shows a flowchart of a method for building and operating a bi-stable solenoid.

FIG. 1 illustrates an example vehicle driveline 199 included in vehicle 10. Mechanical connections are shown in FIG. 1 as solid lines and electrical connections are indicated as dashed lines.

Vehicle 10 includes a front side 110 and a rear side 111. Vehicle 10 includes front wheels 102 and rear wheels 103. In this example, vehicle 10 is configured as a two-wheel drive vehicle; however, in other examples, vehicle 10 may be configured as a four-wheel drive vehicle. Vehicle 10 includes a propulsion source 12 that may selectively provide propulsive effort to rear axle 190. In this example, propulsion source 12 is an electric machine (e.g., a motor/generator), but in other embodiments propulsion source 12 may be an internal combustion engine or a combination of an electric machine and an internal combustion engine. Propulsion source 12 is shown mechanically coupled to gearbox 14, and gearbox 14 is mechanically coupled to rear axle 190. Propulsion source 12 may provide mechanical power to gearbox 14. Rear axle 190 may receive mechanical power from gearbox 14 so that mechanical power may be transmitted to rear wheels 103. Traction battery 139 may supply electric power to propulsion source 12.

Rear axle 190 comprises two half shafts, including a first or right half shaft 190a and a second or left half shaft 190b. The rear axle 190 may be an integrated axle that includes a differential 191. Differential 191 may be open when vehicle 10 is traveling on roads and negotiating curves so that right rear wheel 103a may rotate at a different speed than left rear wheel 103b. Differential 191 allows vehicle 10 to turn without dragging right rear wheel 103a or left rear wheel 103b. Differential 191 may be selectively locked (engaged) or unlocked (disengaged) via bi-stable solenoid actuator 195 so that right half shaft 190a rotates at a same speed as left half shaft 190b.

Controller 144 may selectively lock and unlock differential 191 via sending lock and unlock commands to bi-stable solenoid actuator 195. Controller 144 may lock or unlock differential 191 responsive to speeds of wheels 103a and 103b. For example, controller 144 may lock differential 191 in response to a rotational speed difference between right rear wheel 103a and left rear wheel 103b exceeding a threshold speed difference.

Controller 144 may also communicate with dash board 130, propulsion source 12, and other controllers where present. Controller 144 includes read-exclusive memory (ROM or non-transitory memory) 114, random access memory (RAM) 116, a digital processor or central processing unit (CPU) 160, and inputs and outputs (I/O) 118 (e.g., digital inputs including counters, timers, and discrete inputs, digital outputs, analog inputs, and analog outputs). Controller 144 may receive signals from sensors 154 and provide control signal outputs to actuators 156. Sensors 154 may include but are not limited to wheel speed sensors, a propulsion source temperature sensor, a propulsion source torque sensor, and a propulsion source rotational speed sensor. Actuators 156 may include but are not limited to propulsion source torque actuators (e.g., inverters, etc.).

Vehicle propulsion system may also include a dashboard 130 that an operator of the vehicle may interact with. Dashboard 130 may include an interactive weather data display and notification system 134 that may communicate weather forecast data to controller 144. Dashboard 130 may further include a display system 132 configured to display information to the vehicle operator. Display system 132 may comprise, as a non-limiting example, a touchscreen, or human machine interface (HMI), display which enables the vehicle operator to view graphical information as well as input commands. In some examples, display system 132 may be connected wirelessly to the internet (not shown) via controller 144. As such, in some examples, the vehicle operator may communicate via display system 132 with an internet site or software application (app) and controller 144. Dashboard 130 and devices included therein may be supplied with electrical power via traction battery 139 via a power converter (not shown). Battery 139 may also supply power to controller 114.

Dashboard 130 may further include an operator interface 136 via which the vehicle operator may adjust the operating status of the vehicle. Specifically, the operator interface 136 may be configured to initiate and/or terminate operation of the vehicle driveline (e.g., propulsion source 12) based on an operator input. Various examples of the operator interface 136 may include interfaces that utilize a physical apparatus, such as an active key, that may be inserted into the operator interface 136 to activate the propulsion source 12 and to turn on the vehicle 10, or may be removed to shut down the propulsion source 12 and to turn off the vehicle. Other examples may additionally or optionally use a start/stop button that is manually pressed by the operator to start or shut down the propulsion source 12. Spatial orientation of vehicle 10 is indicated via axes 175.

Referring now to FIG. 2, a perspective view of bi-stable solenoid 195 is shown. Bi-stable solenoid actuator 195 includes an annular steel housing 202, an annular steel piston 206, permanent magnets 210, and an annular steel cover 204. Annular steel cover 204 is fastened to annular steel housing 202 via threaded fasteners 212. A positive terminal +220 and a negative terminal −221 are shown for the windings (not shown) of the bi-stable solenoid actuator 195. Annular steel piston 206 is captured within and its motion may be constrained via annular steel cover 204 and/or annular steel housing 202. The orientation of cross-section AA is also shown.

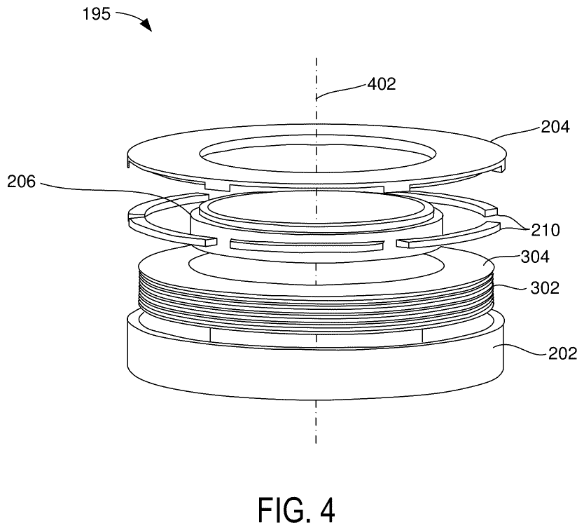

Referring now to FIG. 3, cross-section AA of bi-stable solenoid actuator 195 is shown. The cross-section shows that annular steel housing 202 includes a U-shaped channel 320. The U-shaped channel 320 is at least partially occupied by annular steel piston 206, annular winding carrier 304, and windings 302. The cross-section also illustrates how permanent magnet 210 is in physical contact with annular steel cover 204 and annular steel housing 202. Annular steel piston may move as indicated by arrow 350.

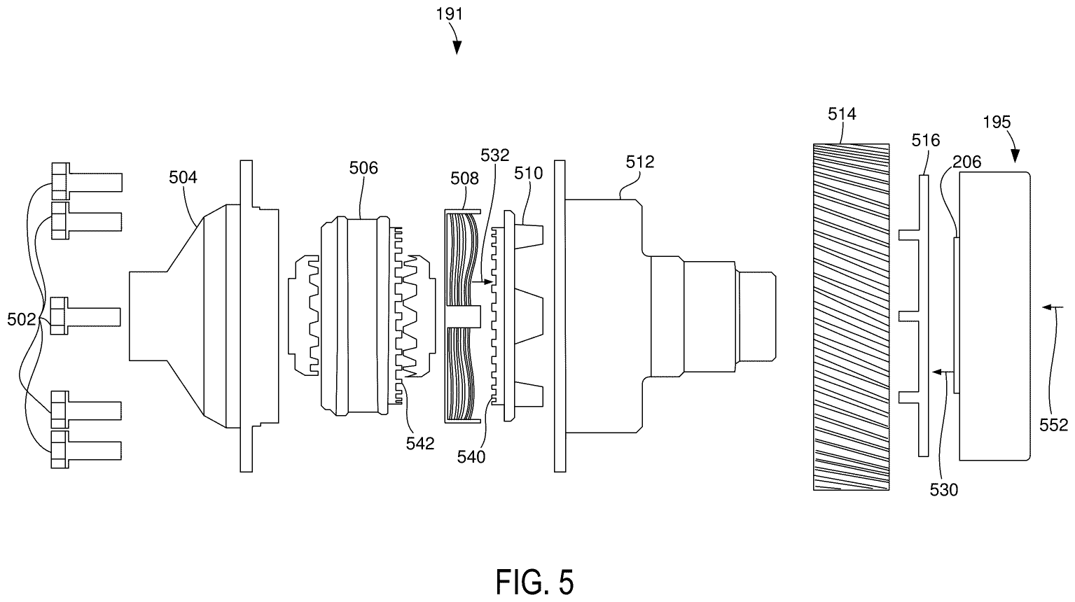

Referring now to FIG. 4, an exploded view of bi-stable solenoid actuator 195 is shown. The annular steel housing 202, annular winding carrier 304, annular steel piston 206, and annular steel cover 204 are concentrically located about a center that is indicated via line 402. In this example, permanent magnets 210 are arranged in a circle about the center that is indicated by line 402. In this example, there are a plurality of permanent magnets, but it may be appreciated that a sole circular permanent magnet may be applied on other examples. The windings 302 are shown wrapped around the winding carrier 304.

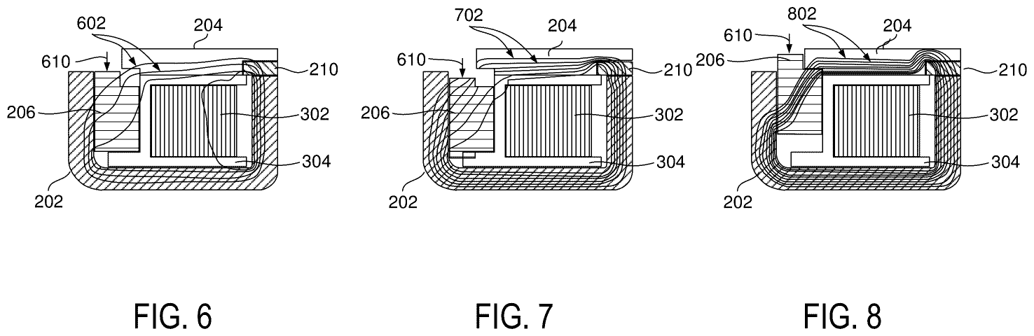

Referring now to FIG. 5, an exploded view of a differential 191 that includes a differential disconnect that may be operated via bi-stable solenoid actuator 195 is shown. Fasteners (e.g., bolts) 502 pass through holes (not shown) in first half of differential split housing 504 and in second half of differential split housing 512. The fasteners 502 couple the first half of differential split housing 504 and the second half of differential split housing 512 to ring gear 514. The first half of differential split housing 504 and in second half of differential split housing 512 cover the differential gear nest 506. Annular steel piston 206 of bi-stable solenoid actuator 195 may apply a force to pressure plate 516 in the direction that is indicated by arrow 530 so as to move cam ring toward differential gear nest 506. This allows cam ring dog teeth 540 to engage differential gear nest dog teeth 542. The second half of split differential housing 512 passes through a through hole in ring gear (not shown) and second half of split differential housing 512 includes through holes (not shown) for the pressure plate to impinge on cam ring 510. Return spring 508 applies a force in the direction of arrow 532 to disengage the cam ring dog teeth 540 from the differential gear nest dog teeth 542. An axle half shaft may be inserted into bi-stable solenoid actuator 195 and differential 191 in the direction that is indicated by arrow 552 so that the axle half shaft interfaces with differential gear nest 506.

Thus, the system of FIGS. 1-5 provides for a bi-stable solenoid actuator, comprising: an annular steel housing that includes a U-shaped channel; a winding wrapped around an annular winding carrier; an annular steel piston; one or more permanent magnets arranged in a circle; an annular steel cover, and a return spring. In a first example, the bi-stable solenoid actuator includes where the winding and the winding carrier are inserted into the U-shaped channel. In a second example that may include the first example, the bi-stable solenoid actuator includes where the annular steel piston is inserted into the U-shaped channel. In a third example that may include one or both of the first and second examples, the bi-stable solenoid actuator includes where the annular steel cover covers a portion of the U-shaped channel. In a fourth example that may include one or more of the first through third examples, the bi-stable solenoid actuator includes where the one or more permanent magnets are positioned between the U-shaped channel and the annular steel cover. In a fifth example that may include one or more of the first through fourth examples, the bi-stable solenoid actuator includes where the annular steel piston is positioned between the U-shaped channel and the annular winding carrier. In a sixth example that may include one or more of the first through fifth examples, the bi-stable solenoid actuator includes where the annular steel housing is configured to receive an axle shaft through a through hole in the annular steel housing.

Additionally, the system of FIGS. 1-5 provides for a bi-stable solenoid actuator, comprising: an annular steel housing that includes a U-shaped channel; a winding wrapped around an annular winding carrier; an annular steel piston, the annular steel piston including an L shaped cross-section; one or more permanent magnets arranged in a circle; an annular steel cover, and a return spring. In a first example, the bi-stable solenoid actuator of claim 16, where the annular steel piston is configured to physically contact the annular steel cover and the U-shaped channel in an engaged position. In a second example that may include the first example, the bi-stable solenoid actuator of claim 16, where the annular steel piston is configured to physically contact the U-shaped channel and not contact the annular steel cover in a disengaged position. In a third example that may include one or both of the first and second examples, the bi-stable solenoid actuator includes, where the annular steel cover is placed in physical contact with the one or more permanent magnets. In a fourth example that may include one or more of the first through third examples, the bi-stable solenoid actuator includes where the one or more permanent magnets are in physical contact with the annular steel housing.

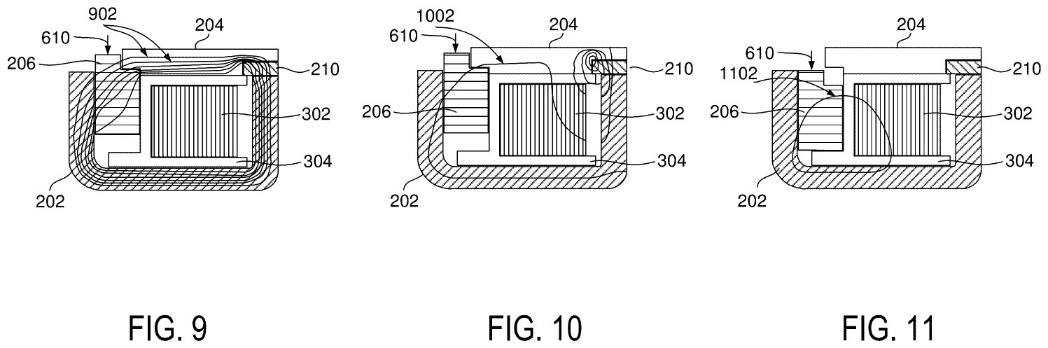

Referring now to FIG. 6, a cross section of bi-stable solenoid actuator 195 that illustrates prophetic magnetic field strength lines when the bi-stable solenoid actuator 195 is disengaged and electric power is not supplied to the bi-stable solenoid actuator 195. In this position, there is a weaker magnetic field as indicated by lines 602 that originate from permanent magnet 210. This magnetic field is not strong enough to overcome the load generated by the return spring (e.g., 508 of FIG. 5). As a result, the piston remains in its disengaged position where the cam ring dog teeth 540 do not engage differential gear nest dog teeth 542. The annular steel piston 206 is in its disengaged position and annular steel cover 204, annular steel housing 202, and annular winding carrier 304 hold annular steel piston 206 within bi-stable solenoid actuator 195.

Referring now to FIG. 7, a cross section of bi-stable solenoid actuator 195 that illustrates prophetic magnetic field strength lines when the bi-stable solenoid actuator 195 is disengaged and electric power is supplied to the bi-stable solenoid actuator 195 in a first direction. In this example, the magnetic field that is generated by supplying electric power to windings 302 and the magnetic field that is generated from permanent magnet 210 combine to generate a stronger magnetic field as indicated by lines 702 that originate from permanent magnet 210. This magnetic field is strong enough to overcome the load generated by the return spring (e.g., 508 of FIG. 5). Consequently, the annular steel piston 208 moves to the position that is shown in FIG. 8 shortly after electric power is applied to the windings 302. The annular steel piston 206 is shown in its disengaged position and annular steel cover 204, annular steel housing 202, and annular winding carrier 304 hold annular steel piston 206 within bi-stable solenoid actuator 195.

Referring now to FIG. 8, a cross section of bi-stable solenoid actuator 195 that illustrates prophetic magnetic field strength lines when the bi-stable solenoid actuator 195 is engaged and electric power is supplied to the bi-stable solenoid actuator 195 in a first direction. Here again, the magnetic field that is generated by supplying electric power to windings 302 and the magnetic field that is generated from permanent magnet 210 combine to generate a stronger magnetic field as indicated by lines 802 that originate from permanent magnet 210. This magnetic field is strong enough to keep the return spring (e.g., 508 of FIG. 5) compressed and the differential locked or engaged. The annular steel piston 206 is shown in its engaged position and annular steel cover 204, annular steel housing 202, and annular winding carrier 304 hold annular steel piston 206 within bi-stable solenoid actuator 195.

Referring now to FIG. 9, a cross section of bi-stable solenoid actuator 195 that illustrates prophetic magnetic field strength lines when the bi-stable solenoid actuator 195 is engaged and without electric power being supplied to the bi-stable solenoid actuator 195 in a first direction. In this example, the magnetic field that is generated from permanent magnet 210 is strong enough to maintain annular steel piston 206 in an engaged or differential locking position. The magnetic field lines are indicated by lines 902 and the magnetic field is strong since there is no air gap between the annular steel cover 204 and the annular steel piston 206. The annular steel piston 206 is shown in its engaged position and annular steel cover 204, annular steel housing 202, and annular winding carrier 304 hold annular steel piston 206 within bi-stable solenoid actuator 195.

Turning now to FIG. 10, a cross section of bi-stable solenoid actuator 195 that illustrates prophetic magnetic field strength lines when the bi-stable solenoid actuator 195 is engaged and electric power is supplied to the bi-stable solenoid actuator 195 in a second direction. Applying the electric power in the second direction causes the magnetic field that is generated from windings 302 to cancel the magnetic field that is generated by permanent magnet 210. Consequently, the resulting magnetic field is not strong enough to overcome the force of return spring 508 shown in FIG. 5. FIG. 10 shows the magnetic field lines that are indicated by lines 902 before the annular steel piston 206 begins to move due to the spring force. The annular steel piston 206 is shown in its engaged position and annular steel cover 204, annular steel housing 202, and annular winding carrier 304 hold annular steel piston 206 within bi-stable solenoid actuator 195.

Referring now to FIG. 11, a cross section of bi-stable solenoid actuator 195 that illustrates prophetic magnetic field strength lines when the bi-stable solenoid actuator 195 is engaged and electric power is supplied to the bi-stable solenoid actuator 195 in the second direction. Here, annular steel piston 206 is shown in a disengaged position where the differential is open and not locked. There is now an air gap between annular steel piston 206 and annular steel cover 204 which helps to disrupt formation of concentrated magnetic field lines that could cause annular steel piston to move to its engaged position. FIG. 11 shows the magnetic field lines that are indicated by lines 1102 after the annular steel piston 206 moves due to the spring force. The annular steel piston 206 is shown in its disengaged position and annular steel cover 204, annular steel housing 202, and annular winding carrier 304 hold annular steel piston 206 within bi-stable solenoid actuator 195.

Turning now to FIG. 12, a method for constructing and applying a bi-stable solenoid actuator is shown. The method of FIG. 12 may be performed via a human or via machines. Further, portions of the method of FIG. 12 may be performed via a controller that includes executable instructions that are stored in non-transitory memory. The controller may apply sensors and actuators to change operating states of the bi-stable solenoid actuator in the real world.

At 1202, method 1200 forms the annular steel housing, the annular winding carrier, the annular steel piston, the differential housing, the pressure plate, the cam ring, and the annular steel cover. These components may be cast, stamped, or formed via other known methods. Method 1200 proceeds to 1204.

At 1204, method 1200 inserts the winding carrier and windings that are wound around the winding carrier into the U-shaped channel of the annular steel housing. Method 1200 proceeds to 1206.

At 1206, method 1200 places permanent magnets in direct contact with the annular steel housing. Method 1200 proceeds to 1208.

At 1208, method 1200 places the annular steel cover over the annular steel housing, annular steel piston, annular winding carrier, windings, and permanent magnets to form a bi-stable solenoid actuator. Method 1200 proceeds to 1210.

At 1210, method 1200 places the bi-stable solenoid actuator in contact with a differential housing. Method 1200 proceeds to 1212.

At 1212, method 1200 places the annular steel piston of the bi-stable solenoid actuator in direct contact with a pressure plate and the pressure plate is in direct contact with a cam ring. Method 1200 proceeds to 1214.

At 1214, method 1200 places an axle shaft through the bi-stable solenoid actuator. Method 1200 proceeds to 1216.

At 1216, method 1200 judges whether or not there is a request to change an operating state of the bi-stable differential locking device (e.g., to open or lock the differential). If so, the answer is yes and method 1200 proceeds to 1218. Otherwise, the answer is no and method 1200 proceeds to exit.

At 1218, method 1200 applies electric power to the windings of the bi-stable solenoid actuator in a first direction to reduce the permanent magnet field to allow the spring to open the differential (e.g., +terminal of battery or power source to a first terminal of the windings and −terminal of the battery or power source to a second terminal of the windings), or alternatively, in a second direction to lock the differential (lock the axle shafts together) (e.g., +terminal of battery or power source to the second terminal of the windings and −terminal of the battery or power source to the first terminal of the windings). Method 1200 proceeds to 1220.

At 1220 method 1200 judges whether or not the bi-stable solenoid actuator has changed its operating state. If so, the answer is yes and method 1200 proceeds to 1222. Otherwise, the answer is no and method 1200 returns to 1218.

At 1222, method 1200 removes electric power from the windings of the bi-stable solenoid actuator to conserve electric power. Method 1200 proceeds to exit.

Thus, method 1200 provides for construction and applying a bi-stable solenoid actuator. The bi-stable solenoid actuator is annular in shape so that a uniform pressure may be applied to a pressure plate and cam ring so that a possibility of binding of the mechanism may be reduced.

The method of FIG. 12 provides for a method for a bi-stable solenoid actuator, comprising: forming an annular steel housing that includes a U-shaped channel; forming an annular winding carrier and wrapping a winding around the annular winding carrier; inserting the annular winding carrier and the winding within the U-shaped channel; placing one or more permanent magnets in direct contact with the annular steel housing; placing an annular steel cover over at least a portion of the U-shaped channel; and installing the bi-stable solenoid actuator to a differential housing. In a first example, the method further comprises inserting an axle shaft through the bi-stable solenoid actuator. In a second example that may include the first example, the method further comprises applying electric power in a first direction to the winding in response to a differential lock request. In a third example that may include one or both of the first and second examples, the method further comprises applying electric power in a second direction to the winding in response to a differential unlock request. In a fourth example that may include one or more of the first through third examples, the method further comprises removing electric power from the winding while a differential is locked and maintaining the differential locked. In a fifth example that may include one or more of the first through fourth examples, the method further comprises inserting an annular steel piston within the U-shaped channel and within a through hole of the annular winding carrier. In a sixth example that may include one or more of the first through fifth examples, the method further comprises placing the annular steel piston in contact with a pressure plate. In a seventh example that may include one or more of the first through sixth examples, the method further comprises placing the pressure plate in contact with a cam ring.

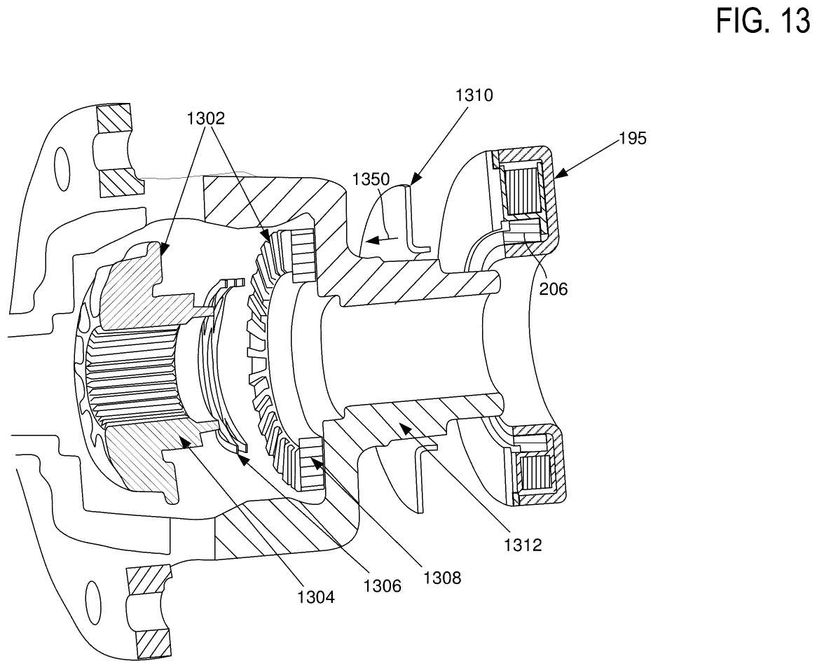

Referring now to FIG. 13, a cut-away section of an electronic differential lock and portion of a differential is shown. In particular, FIG. 13 shows differential case 1312 and within case 132 a locking side gear 1304 is shown along with a return spring 1306 and a cam ring 1308. The cam ring 1308 and locking side gear 1304 include dog teeth 1302 that may engage each other to lock the locking side gear 1304. Bi-stable solenoid actuator 195 fits over a portion of case 132 and it may apply a force to pressure plate 1310 causing pressure plate 1310 to move in the direction that is indicated by arrow 1350.

The electronic differential lock may operate as follows: with cam ring 1308 in a disconnected state, annular steel piston 206 is held open via return spring 1306 and solenoid magnets (not shown). Applying electric power to the windings (not shown) of bi-stable solenoid actuator 195 causes annular steel piston 206 to move to an engaged state where return spring 1306 is compressed and dog teeth of cam ring 1308 engage dog teeth of locking side gear 1304. The electric power may be removed from the windings (not shown) of the bi-stable solenoid actuator 195. Even so, the permanent magnets (not shown) of the bi-stable solenoid actuator 195 keep the annular steel piston 206 in the engaged state. Electric power may be applied in a second direction to the windings of the bi-stable solenoid actuator 195 to break the magnetic field of the permanent magnets. This allows the return spring to disconnect the cam ring 1308 from the locking side gear 1304 to unlock the differential. The disconnection is facilitated by the return spring since there is no action produced via the windings to move the annular steel piston 206.

While various embodiments have been described above, it may be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for tandem axles, electric tag axles, P4 axles, HEVs, BEVs, agriculture, marine, motorcycle, recreational vehicles and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

Note that the example construction and control routines included herein may be used with various system configurations. In some examples, the control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing be different than what is described herein to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the term “approximately” is construed to mean plus or minus five percent of the range, unless otherwise specified.

1. A bi-stable solenoid actuator, comprising:
an annular steel housing that includes a U-shaped channel;
a winding wrapped around an annular winding carrier;
an annular steel piston;
one or more permanent magnets arranged in a circle;
an annular steel cover; and
a return spring.

2. The bi-stable solenoid actuator of claim 1, where the winding and the annular winding carrier are inserted into the U-shaped channel.

3. The bi-stable solenoid actuator of claim 2, where the annular steel piston is inserted into the U-shaped channel.

4. The bi-stable solenoid actuator of claim 3, where the annular steel cover covers a portion of the U-shaped channel.

5. The bi-stable solenoid actuator of claim 4, where the one or more permanent magnets are positioned between the U-shaped channel and the annular steel cover.

6. The bi-stable solenoid actuator of claim 5, where the annular steel piston is positioned between the U-shaped channel and the annular winding carrier.

7. The bi-stable solenoid actuator of claim 6, where the annular steel housing is configured to receive an axle shaft through a through hole in the annular steel housing.

8. A method for a bi-stable solenoid actuator, comprising:
forming an annular steel housing that includes a U-shaped channel;
forming an annular winding carrier and wrapping a winding around the annular winding carrier;
inserting the annular winding carrier and the winding within the U-shaped channel;
placing one or more permanent magnets in direct contact with the annular steel housing;
placing an annular steel cover over at least a portion of the U-shaped channel; and
installing the bi-stable solenoid actuator to a differential housing.

9. The method of claim 8, further comprising inserting an axle shaft through the bi-stable solenoid actuator.

10. The method of claim 8, further comprising applying electric power in a first direction to the winding in response to a differential lock request.

11. The method of claim 10, further comprising applying electric power in a second direction to the winding in response to a differential unlock request to reduce the permanent magnet field to allow the return spring to open the differential.

12. The method of claim 10, further comprising removing electric power from the winding while a differential is locked and maintaining the differential locked.

13. The method of claim 8, further comprising inserting an annular steel piston within the U-shaped channel and within a through hole of the annular winding carrier.

14. The method of claim 13, further comprising placing the annular steel piston in contact with a pressure plate.

15. The method of claim 14, further comprising placing the pressure plate in contact with a cam ring.

16. A bi-stable solenoid actuator, comprising:
an annular steel housing that includes a U-shaped channel;
a winding wrapped around an annular winding carrier;
an annular steel piston, the annular steel piston including an L shaped cross-section;
one or more permanent magnets arranged in a circle;
an annular steel cover; and
a return spring.

17. The bi-stable solenoid actuator of claim 16, where the annular steel piston is configured to physically contact the annular steel cover and the U-shaped channel in an engaged position.

18. The bi-stable solenoid actuator of claim 16, where the annular steel piston is configured to physically contact the U-shaped channel and not contact the annular steel cover in a disengaged position.

19. The bi-stable solenoid actuator of claim 18, where the annular steel cover is placed in physical contact with the one or more permanent magnets.

20. The bi-stable solenoid actuator of claim 19, where the one or more permanent magnets are in physical contact with the annular steel housing.
